(19) United States
(12) Patent Application Publication
(10) Pub. No.: US 2016/0062843 A1
(43) Pub. Date: Mar. 3, 2016

(54) METHODS AND DEVICES FOR BACKING UP FILE

(71) Applicant: Xiaomi Inc., Beijing (CN)

(72) Inventors: Chunyu LI, Beijing (CN); Yidong WANG, Beijing (CN); Xiandong HU, Beijing (CN)

(73) Assignee: Xiaomi Inc

(21) Appl. No.: 14/694,080

(22) Filed: Apr. 23, 2015

Related U.S. Application Data
(63) Continuation of application No. PCT/CN2015/071870, filed on Jan. 30, 2015.

(30) Foreign Application Priority Data
Aug. 27, 2014 (CN) 201410429701.7

(51) Int. Cl. G06F 11/14; G06F 17/30

(52) U.S. Cl. CPC G06F 11/1451; G06F 11/1461; G06F 17/30082; G06F 2201/80; G06F 2201/84

(57) ABSTRACT

A method for backing up files to a back-up server includes determining a hash value of a file according to a preset algorithm, inquiring for the determined hash value in a local back-up database, and canceling back-up of the file to the back-up server if the hash value is recorded in the local back-up database.

This application is a continuation of International Application No. PCT/CN2015/071870, filed Jan. 30, 2015, which is based upon and claims priority to Chinese Patent Application No. CN201410429701.7 filed Aug. 27, 2014, the entire contents of both of which are incorporated herein by reference.

### TECHNICAL FIELD

The present disclosure relates to storage and, more particularly, to methods and devices for backing up a file.

### BACKGROUND

Mobile devices are nowadays widely used. Often time, people need to automatically backup files on the mobile devices. However, local storage space in mobile devices is often insufficient.

### SUMMARY

In accordance with the present disclosure, there is provided a method for backing up files to a back-up server. The method includes determining a hash value of a file according to a preset algorithm, inquiring for the determined hash value in a local back-up database, and canceling back-up of the file to the back-up server if the hash value is recorded in the local back-up database.

Also in accordance with the present disclosure, there is provided a method for backing up files. The method includes receiving an inquiring request sent by a terminal. The inquiring request carries an inquiring hash value. The method further includes inquiring for the inquiring hash value in a server back-up database and informing the terminal that a file corresponding to the inquiring hash value has previously been successfully uploaded if the inquiring hash value is recorded in the server back-up database.

Also in accordance with the present disclosure, there is provided a device for backing up files including a processor and a non-transitory computer-readable storage medium storing instructions. The instructions, when executed by the processor, cause the processor to determine a hash value of a file according to a preset algorithm, inquire for the determined hash value in a local back-up database, and cancel back-up of the file to the back-up server if the hash value is recorded in the local back-up database.

Also in accordance with the present disclosure, there is provided a device for backing up files including a processor and a non-transitory computer-readable storage medium storing instructions. The instructions, when executed by the processor, cause the processor to inquire for an inquiring hash value in a server back-up database in response to an inquiring request sent by a terminal and carrying an inquiring hash value, and inform the terminal that a file corresponding to the inquiring hash value has previously been successfully uploaded if the inquiring hash value is recorded in the server back-up database.

Also in accordance with the present disclosure, there is provided a non-transitory computer-readable storage medium storing instructions. The instructions, when executed by one or more processors of a terminal, cause the terminal to determine a hash value of a file according to a preset algorithm, inquire for the determined hash value in a local back-up database, and cancel back-up of the file to the back-up server if the hash value is recorded in the local back-up database.

Also in accordance with the present disclosure, there is provided a non-transitory computer-readable storage medium storing instructions. The instructions, when executed by one or more processors of a device, cause the device to inquire for an inquiring hash value in a server back-up database in response to an inquiring request sent by a terminal and carrying an inquiring hash value, and inform the terminal that a file corresponding to the inquiring hash value has previously been successfully uploaded if the inquiring hash value is recorded in the server back-up database.

It is to be understood that both the foregoing general description and the following detailed description are exemplary and explanatory only, and do not limit the scope of the disclosure.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a flow chart of a method for backing up a file, according to an exemplary embodiment.

FIG. 2 is a schematic diagram showing extraction of file fragments from a video file, according to an exemplary embodiment.

FIG. 3 is a flow chart of a method for backing up a file, according to another exemplary embodiment.

FIG. 4 is a flow chart of a method for backing up a file, according to a further exemplary embodiment.

FIG. 5 is a block diagram of a device for backing up a file, according to an exemplary embodiment;

FIG. 6 is a block diagram of an exemplary first determining module, according to an exemplary embodiment.

FIG. 7 is a block diagram of an exemplary first determining sub-module, according to an exemplary embodiment.

FIG. 8 is a block diagram of a device for backing up a file, according to another exemplary embodiment.

FIG. 9 is a block diagram of a device for backing up a file, according to a further exemplary embodiment.

FIG. 10 is a block diagram of an exemplary processing module, according to an exemplary embodiment.

FIG. 11 is a block diagram of a device for backing up a file, according to a further exemplary embodiment.

FIG. 12 is a block diagram of a device for backing up a file, according to a further exemplary embodiment.

FIG. 13 is a block diagram of a device for backing up a file, according to a further exemplary embodiment.

FIG. 14 is a block diagram of an exemplary second determining module, according to an exemplary embodiment.

FIG. 15 is a block diagram of an exemplary third determining sub-module, according to an exemplary embodiment.

FIG. 16 is a block diagram of a configuration of a device for backing up a file, according to an exemplary embodiment.

FIG. 17 is a block diagram of a configuration of a device for backing up a file, according to another exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of devices and methods consistent with aspects related to the disclosure as recited in the appended claims.

Terminology used in the present disclosure is merely for the purpose of describing particular embodiments, and not intended to limit the present disclosure. As used in the present disclosure and the appended claims, “an”, “said”, and “the” in singular forms are intended to include plural forms, unless the context definitely indicates otherwise. It should also be understood that the term “and/or” used herein means and includes any or all possible combinations of one or more of the associated listed items.

It should be understood that, although the terms “first”, “second”, “third”, etc., are used in the present disclosure to describe a variety of information, the information should not be limited by these terms. These terms are merely used to distinguish information of one type. For example, without departing from the scope of the present disclosure, first information may also be referred to as second information. Similarly, the second information may also be referred to as the first information. Depending on the context, as used herein, the word “if” may be interpreted as “where . . . ,” “when . . . ,” or “in response to.”

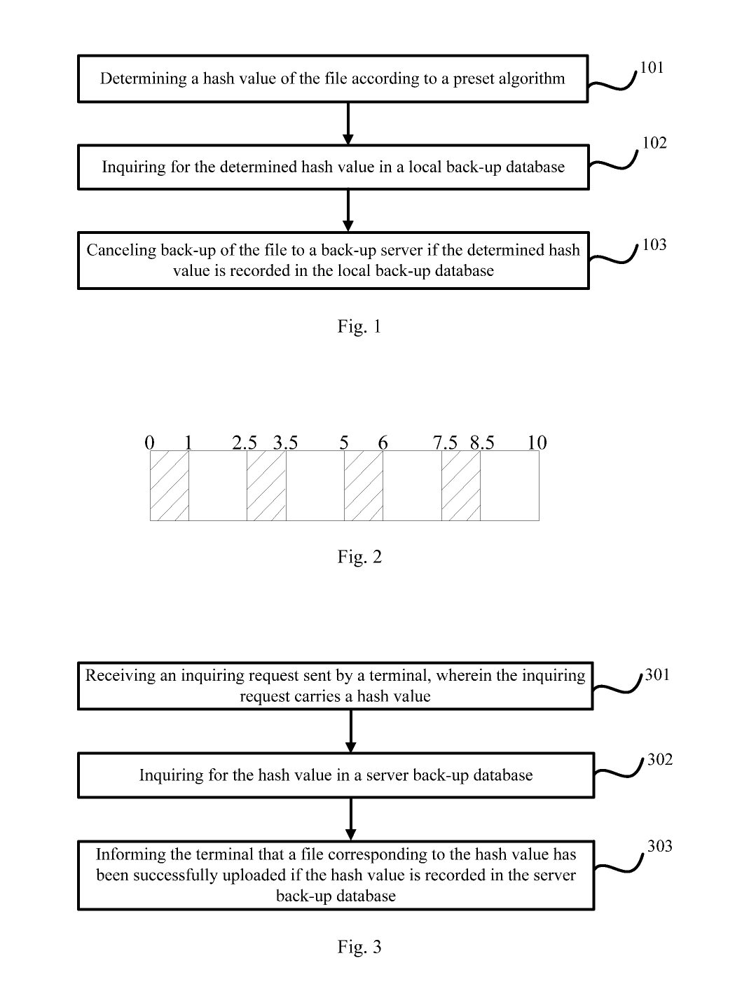

FIG. 1 is a flow chart of a method for backing up a file, according to an exemplary embodiment. The method in FIG. 1 can be implemented in a terminal. As shown in FIG. 1, at 101, a hash value of the file is determined according to a preset algorithm. In some embodiments, the preset algorithm may include performing a thresholding process on the file before determining the hash value, and applying different methods for determining a hash value based on results of the thresholding process.

For example, it may be judged whether a size of the file is larger than a preset threshold. If the size of the file is not larger than the preset threshold, the hash value is directly determined based on the file. If the size of the file is larger than the preset threshold, then directly calculating the hash value of the file may include a large amount of workload, which in turn increases power consumption. Accordingly, for a file larger than the preset threshold, several file fragments each having a preset size may be extracted from the file, and a hash value is determined based on the file fragments. The hash value so determined is then used as the hash value of the file. For example, extracting the file fragments from the file may include dividing the file into several file blocks each having the preset size, and then selecting some file blocks as the file fragments.

The preset size is smaller than the preset threshold. The preset threshold can be set according to practical conditions, or may take an empirical value. For example, to back up a video or picture file using the method of the present disclosure, the preset threshold can take an empirical value of 4M.

The file fragments may be extracted from the file either randomly or evenly. Randomly extracted file fragments may be distributed unevenly in the file. In this scenario, an error may exist between a hash value determined according to the unevenly distributed file fragments and a hash value determined according to the file. Accordingly, in order to reduce the error between the hash value determined according to the file fragments and the hash value determined according to the file, the file fragments may be evenly extracted from the file. For example, the file fragments may be extracted at a fixed interval, so that the extracted file fragments are evenly distributed in the file.

In some embodiments, the number of extracted file fragments can be determined by balancing the system resources required for determining the hash value and the required accuracy of the determined hash value. In some embodiments, an empirical value may be employed for determining how many file fragments need to be extracted.

For example, assume that the terminal needs to back up a local video file having a size of 10M, and an empirical value of 4M is employed for the preset threshold T. In this scenario, the size of the video file is larger than the preset threshold. Thus, 4 file fragments each having a preset size of, for example, an empirical value of 1M, may be extracted from the video file.

Particularly, the video file is divided into 4 file blocks of 2.5M each, and then a file fragment of 1M is extracted from each file block. Moreover, in order to ensure that the file fragments are evenly distributed in the video file, a fixed interval may be set between file fragments. For example, file fragments may be extracted according to the following interval function:
[KP, KP+1].
   In this interval function, P represents a size of each file block, K takes a value from (0, 1, . . . , T−1), and T represents the preset threshold. In the above example, P is 2.5, K takes a value from (0, 1, 2, 3). According to the above interval function, as shown in FIG. 2, four file fragments each having a size of 1M are extracted from the video file at a fixed interval of 1.5M, which are [0, 1M], [2.5M, 3.5M], [5M, 6M] and [7.5M, 8.5M], respectively.

At 102, the determined hash value is inquired for in a local back-up database. If the determined hash value is not recorded in the local back-up database, the file corresponding to the determined hash value is uploaded to a back-up server and, thereafter, the determined hash value is saved in the local back-up database.

At 103, if the determined hash value is recorded in the local back-up database, then the file is not uploaded to the back-up server. That is, when it is determined that the determined hash value has been already recorded in the local back-up database, it means that the file has already been uploaded to the back-up server. Therefore, the file will not be backed up to the back-up server again, so as to avoid repeatedly backing up the same file.

In some embodiments, after a file corresponding to a hash value has been successfully uploaded to the back-up server, that hash value is marked as uploaded in the local back-up database. If a determined hash value is found in the local back-up database, it is determined whether the file corresponding to the determined hash value has been successfully uploaded by inquiring whether the determined hash value is marked as uploaded in the local back-up database. If the determined hash value is marked as uploaded, which means that the file corresponding to the determined hash value has been successfully uploaded, the file will not be uploaded to the back-up server again. On the other hand, if the determined hash value is not marked as uploaded, which means it is possible that the file has not been successfully uploaded, the back-up server is inquired about whether the file has been successfully uploaded. If the back-up server indicates that the file corresponding to the determined hash value has been successfully uploaded, then the file will not be uploaded to the back-up server again. If the back-up server indicates that the file corresponding to the determined hash value has not been successfully uploaded, the file is backed up to the back-up server again.

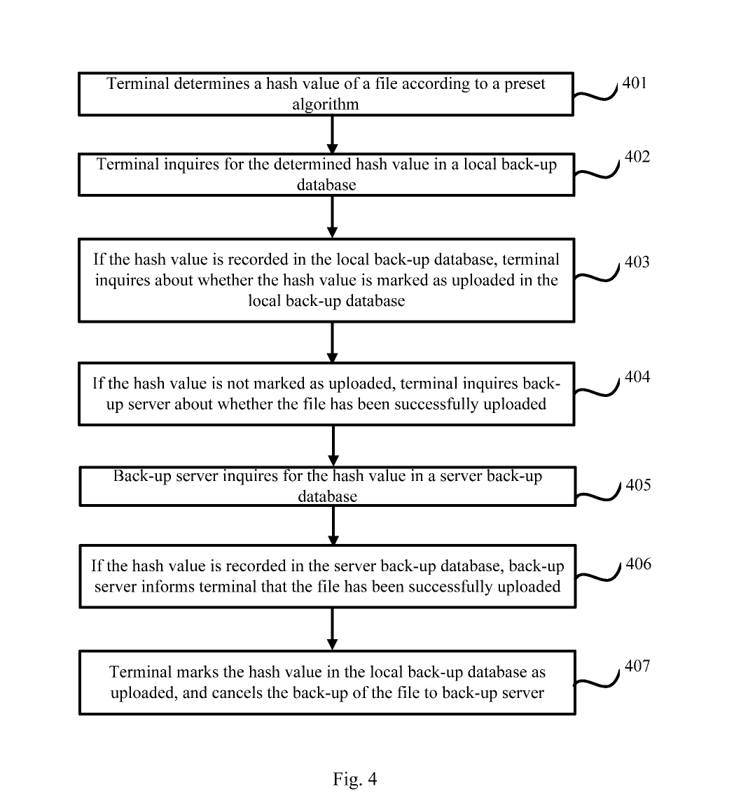

FIG. 3 is a flow chart of another method for backing up a file, according to an exemplary embodiment. The method in FIG. 3 can be implemented in a back-up server. As shown in FIG. 3, at 301, an inquiring request sent by a terminal is received. The inquiring request carries a hash value.

At 302, the received hash value is inquired for in a back-up database of the back-up server (hereinafter referred to as a “server back-up database”).

According to the present disclosure, after the back-up server receives a file uploaded by the terminal, a hash value of the file is determined according to a preset algorithm. After the back-up server successfully backs up the file, it informs the terminal. Meanwhile, the determined hash value is saved in the server back-up database for the terminal to inquire for. The preset algorithm used by the back-up server to determine the hash value of a file is similar to that used by the terminal, and thus the details thereof are omitted here.

At 303, if the received hash value is recorded in the server back-up database, the terminal is informed that a file corresponding to the hash value has already been successfully uploaded. That is, if the received hash value is recorded in the server back-up database, which means that the file inquired by the terminal has previously been successfully uploaded to the back-up server, then the back-up server may send a message to the terminal informing the terminal that the file has already been successfully uploaded, so that the terminal knows that it does not need to back up the file to the back-up server. On the other hand, if the received hash value is not recorded in the server back-up database, the back-up server may send a message to the terminal informing the latter that the file has not been successfully uploaded, so that the terminal backs up the file to the back-up server after it receives the message.

FIG. 4 is a flow chart of another method for backing up a file, according to an exemplary embodiment. As shown in FIG. 4, at 401, a terminal determines a hash value of the file according to a preset algorithm. The preset algorithm is similar to that described above, and thus details of the algorithm are omitted here.

At 402, the terminal inquires for the hash value in a local back-up database. If the hash value is not recorded in the local back-up database, the file corresponding to the hash value is backed up to a back-up server. Thereafter, the determined hash value is saved in the local back-up database. Moreover, after the terminal learns that the file corresponding to the hash value has been successfully uploaded to the back-up server, the terminal marks the hash value as uploaded in the local back-up database. In some embodiments, the back-up server sends a notification message to the terminal after the file has been successfully uploaded to the back-up server.

At 403, if the terminal finds out that the hash value is recorded in the local back-up database, it further inquires whether the hash value is marked as uploaded in the local back-up database. If marked as uploaded, the file will not be backed up to the back-up server.

At 404, if the terminal finds out that the hash value is not marked as uploaded, it inquires of the back-up server whether the file corresponding to the hash value has been successfully uploaded. In some embodiments, the terminal may send an inquiry request carrying the hash value to the back-up server.

At 405, the back-up server inquires for the hash value in a server back-up database.

At 406, if the back-up server finds out that the hash value is recorded in the server back-up database, it informs the terminal that a file corresponding to the hash value has been successfully uploaded. In some embodiments, the server informs the terminal by sending a notification message.

At 407, the terminal marks the hash value in the local back-up database as uploaded, and cancels the back-up of the file to the back-up server. That is, after the terminal receives the notification message sent by the back-up server and learns that the file corresponding to the hash value has been successfully uploaded, it marks the hash value as uploaded and cancels the back-up of the file to the back-up server. On the other hand, if the terminal finds out that the file corresponding to the hash value has not been successfully uploaded, it backs up the file to the back-up server. After the file has been successfully backed up to the back-up server, the terminal marks the hash value corresponding to the file as uploaded in the local back-up database.

In some embodiments, property information of the file may be recorded in the local back-up database. The property information may contain, for example, a latest modification time and a size of the file, etc. When the property information of the file is different from the property information recorded in the local back-up database, this means that the file has been modified or new contents have been added to the file. In this situation, the hash value of the file needs to be re-determined to update the hash value recorded in the local back-up database, and the property information of the file also needs to be updated. On the other hand, if the property information recorded in the local back-up database is the same as the actual property information of the file, the local back-up database does not need to be updated, and the saved values in the local back-up database can be directly used.

Exemplary devices consistent with embodiments of the present disclosure for backing up a file are described below. These devices can be used to implement part or all of the methods consistent with embodiments of the present disclosure, such as those described above.

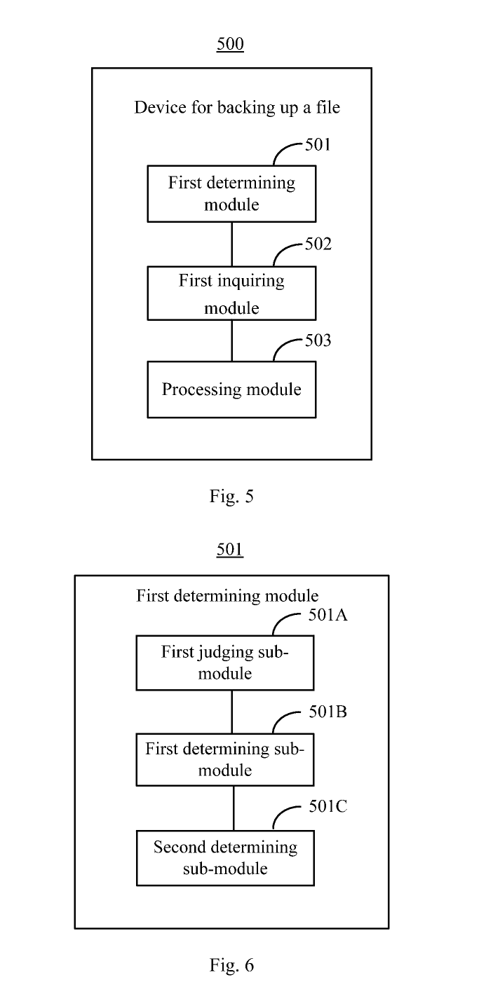

FIG. 5 is a block diagram of a device 500 for backing up a file, according to an exemplary embodiment, which may be implemented in a terminal. The device 500 includes a first determining module 501, a first inquiring module 502, and a processing module 503. The first determining module 501 is configured to determine a hash value of the file according to a preset algorithm. The first inquiring module 502 is configured to inquire for the determined hash value in a local back-up database. The processing module 503 is configured to cancel the back-up of the file to a back-up server if the determined hash value is recorded in the local back-up database.

FIG. 6 is a block diagram schematically showing an example of the first determining module 501 consistent with embodiments of the present disclosure. As shown in FIG. 6, the first determining module 501 includes a first judging sub-module 501A, a first determining sub-module 501B, and a second determining sub-module 501C. The first judging sub-module 501A is configured to judge whether a size of the file is larger than or equal to a preset threshold. The first determining sub-module 501B is configured to extract file fragments from the file if the size of the file is larger than or equal to the preset threshold, and determine a hash value according to the file fragments as the hash value of the file. The second determining sub-module 501C is configured to determine a hash value according to the file as the hash value of the file, if the size of the file is smaller than the preset threshold.

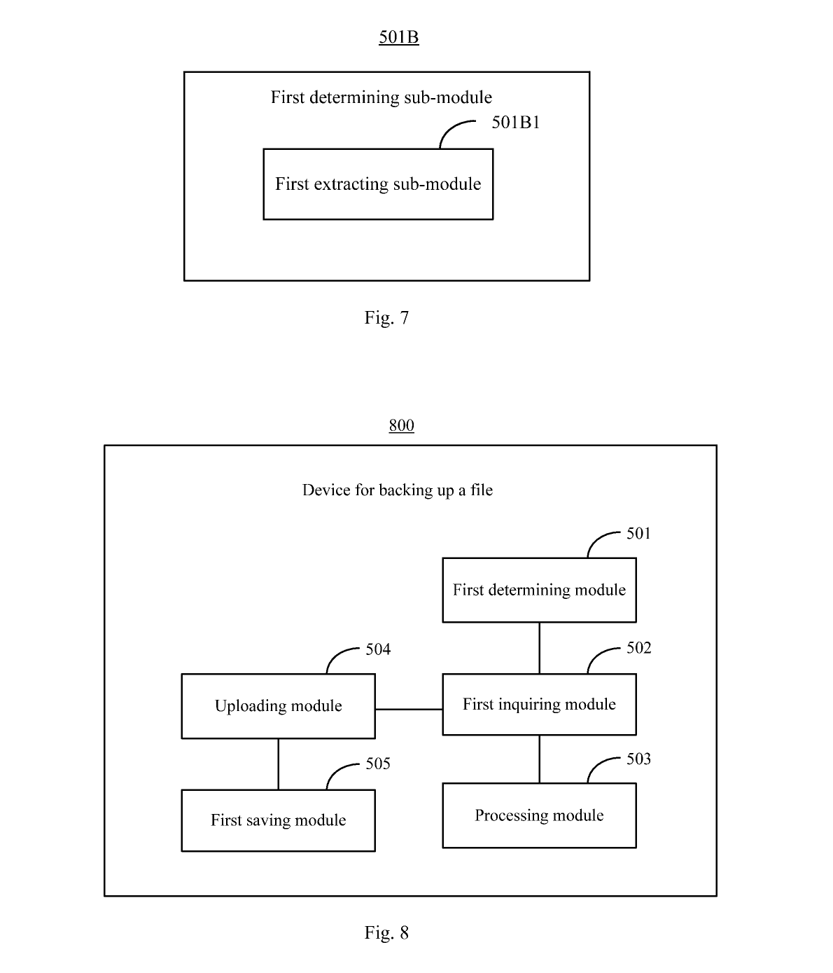

FIG. 7 is a block diagram schematically showing an example of the first determining sub-module 501B. As shown in FIG. 7, the first determining sub-module 501B includes a first extracting sub-module 501B1 configured to evenly extract the file fragments each having a preset size from the file. The number of bytes of each of the file fragments is smaller than the preset threshold.

FIG. 8 is a block diagram of another device 800 for backing up a file, according to an exemplary embodiment. The device 800 is similar to the device 500, except that the device 800 further includes an uploading module 504 and a first saving module 505. The uploading module 504 is configured to upload the file corresponding to the hash value to the back-up server if the hash value is not recorded in the local back-up database. The first saving module 505 is configured to save the hash value in the local back-up database after the file corresponding to the hash value is uploaded to the back-up server.

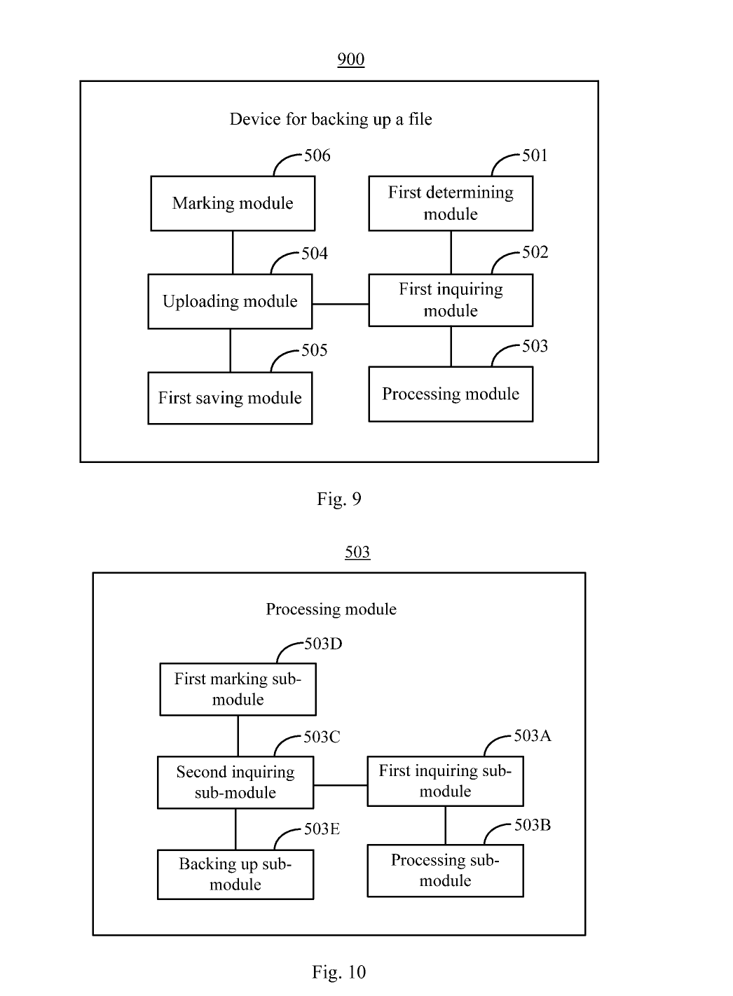

FIG. 9 is a block diagram of another device 900 for backing up a file, according to an exemplary embodiment. The device 900 is similar to the device 800, except that the device 900 further includes a marking module 506 configured to mark the hash value as uploaded in the local back-up database after the file corresponding to the hash value is successfully uploaded to the back-up server.

FIG. 10 is a block diagram schematically showing an example of the processing module 503. As shown in FIG. 10, the processing module 503 includes a first inquiring sub-module 503A, a processing sub-module 503B, a second inquiring sub-module 503C, a first marking sub-module 503D, and a backing up sub-module 503E. The first inquiring sub-module 503A is configured to inquire whether the hash value is marked as uploaded in the local back-up database before canceling the back-up of the file to the back-up server. The processing sub-module 503B is configured to cancel the back-up of the file to a back-up server if the hash value is marked as uploaded. The second inquiring sub-module 503C is configured to inquire of the back-up server whether the file corresponding to the hash value has been successfully uploaded if the hash value is not marked as uploaded. The first marking sub-module 503D is configured to mark the hash value as uploaded in the local back-up database if the file corresponding to the hash value has been successfully uploaded, and cancel the back-up of the file to the back-up server. The backing up sub-module 503E is configured to back up the file to the back-up server if the file corresponding to the hash value has not been successfully uploaded.

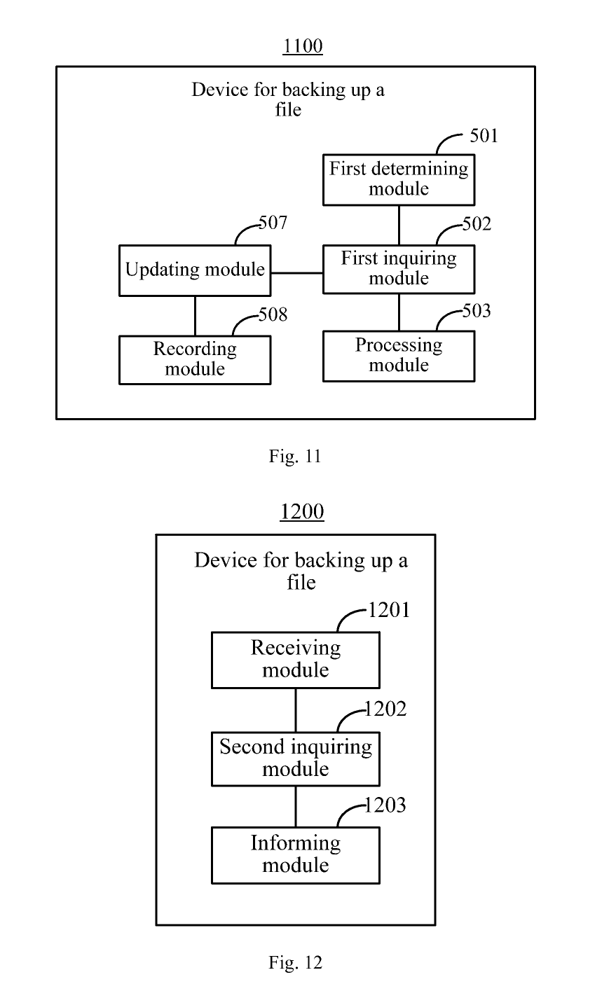

FIG. 11 is a block diagram of another device 1100 for backing up a file, according to an exemplary embodiment The device 1100 is similar to the device 500 except that the device 1100 further includes a recording module 508 and an updating module 507. The recording module 508 is configured to record property information of the file in the local back-up database. The property information includes a latest modification time and a size of the file. The updating module 507 is configured to update the hash value and the property information of the file that are recorded in the local back-up database when the property information of the file is different from the property information recorded in the local back-up database.

FIG. 12 is a block diagram of another device 1200 for backing up a file, according to an exemplary embodiment, which can be implemented in a back-up server. As shown in FIG. 12, the device 1200 includes a receiving module 1201, a second inquiring module 1202, and an informing module 1203. The receiving module 1201 is configured to receive an inquiring request sent by a terminal. The inquiring request carries a hash value. The second inquiring module 1202 is configured to inquire for the hash value in a server back-up database. The informing module 1203 is configured to inform the terminal that a file corresponding to the hash value has been successfully uploaded if the hash value is recorded in the server back-up database.

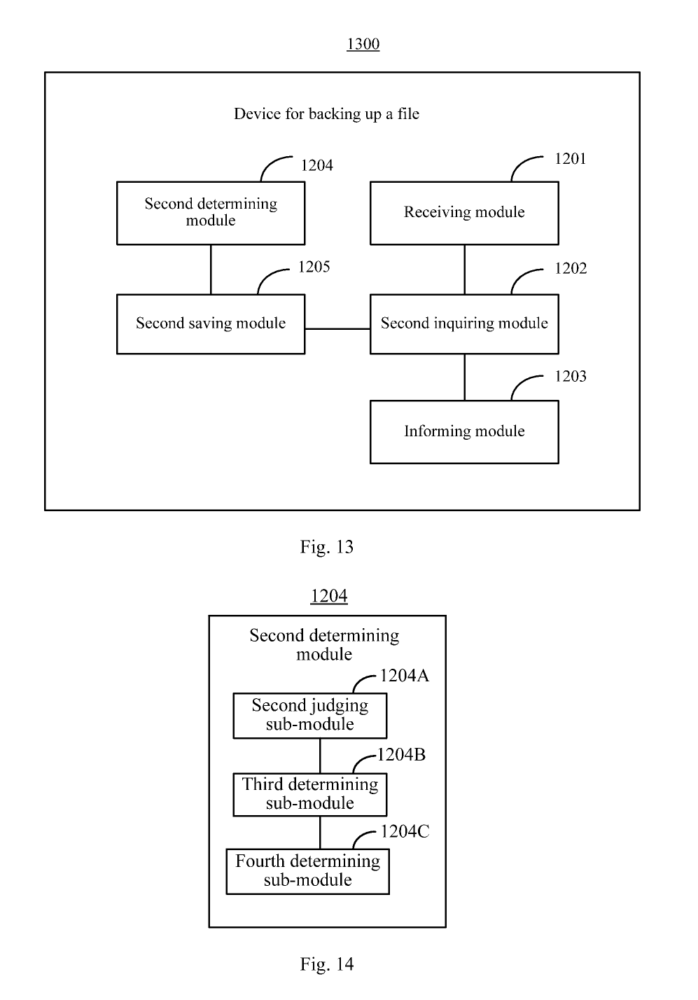

FIG. 13 is a block diagram of another device 1300 for backing up a file, according to an exemplary embodiment. The device 1300 is similar to the device 1200 except that the device 1300 further includes a second determining module 1204 and a second saving module 1205. The second determining module 1204 is configured to determine the hash value of the file uploaded by the terminal according to a preset algorithm. The second saving module 1205 is configured to save the determined hash value in the server back-up database after the file is successfully backed up in the server.

FIG. 14 is a block diagram schematically showing an example of the second determining module 1204. As shown in FIG. 14, the second determining module 1204 includes a second judging sub-module 1204A, a third determining sub-module 1204B, and a fourth determining sub-module 1204C. The second judging sub-module 1204A is configured to judge whether a size of the file is larger than or equal to a preset threshold. The third determining sub-module 1204B is configured to extract file fragments from the file if the size of the file is larger than or equal to the preset threshold, and determine a hash value according to the file fragments as the hash value of the file. The fourth determining sub-module 1204C is configured to determine a hash value according to the file as the hash value of the file if the size of the file is smaller than the preset threshold.

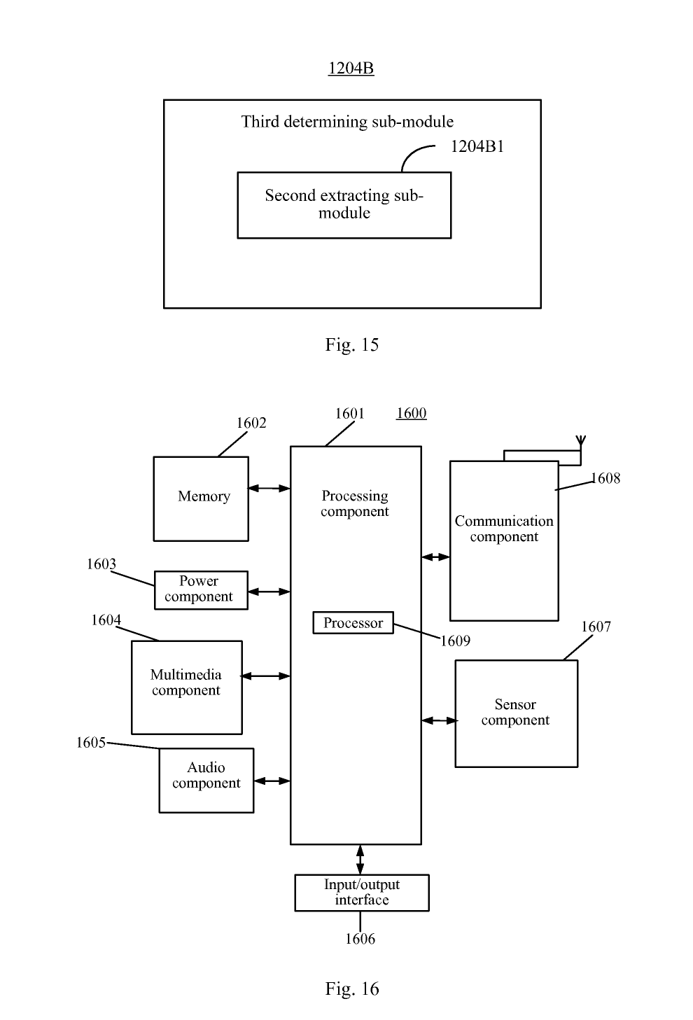

FIG. 15 is a block diagram schematically showing an example of the third determining sub-module 1204B. As shown in FIG. 15, the third determining sub-module 1204B includes a second extracting sub-module 1204B1 configured to evenly extract the file fragments each having a preset size from the file. The total number of bytes of the file fragments is smaller than the preset threshold.

The present disclosure further provides a device for backing up a file. The device include a memory and one or more programs stored in the memory. The one or more programs, when executed by one or more processors, cause the one or more processors to perform a method consistent with embodiments of the present disclosure, such as those described above.

FIG. 16 is a block diagram of a configuration of a device 1600 for backing up a file, according to an exemplary embodiment. The device 1600 may be a mobile phone, a computer, a digital broadcast terminal, a messaging device, a gaming console, a tablet, a medical device, exercise equipment, a personal digital assistant, or the like.

Referring to FIG. 16, the device 1600 includes one or more of the following components: a processing component 1601, a memory 1602, a power component 1603, a multimedia component 1604, an audio component 1605, an input/output (I/O) interface 1606, a sensor component 1607, and a communication component 1608.

The processing component 1601 typically controls overall operations of the device 1600, such as the operations associated with display, telephone calls, data communications, camera operations, and recording operations. The processing component 1601 may include one or more processors 1609 to execute instructions to perform all or part of the steps in the above described methods. Moreover, the processing component 1601 may include one or more modules which facilitate the interaction between the processing component 1601 and other components. For instance, the processing component 1601 may include a multimedia module to facilitate the interaction between the multimedia component 1604 and the processing component 1601.

The memory 1602 is configured to store various types of data to support the operation of the device 1600. Examples of such data include instructions for any applications or methods operated on the device 1600, contact data, phonebook data, messages, pictures, video, etc. The memory 1602 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1603 provides power to various components of the device 1600. The power component 1603 may include a power management system, one or more power sources, and any other components associated with the generation, management, and distribution of power in the device 1600.

The multimedia component 1604 includes a screen providing an output interface between the device 1600 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1604 includes a front camera and/or a rear camera. The front camera and the rear camera may receive an external multimedia datum while the device 1600 is in an operation mode, such as a photographing mode or a video mode. Each of the front camera and the rear camera may be a fixed optical lens system or have focus and optical zoom capability.

The audio component 1605 is configured to output and/or input audio signals. For example, the audio component 1605 includes a microphone (“MIC”) configured to receive an external audio signal when the device 1600 is in an operation mode, such as a call mode, a recording mode, and a voice recognition mode. The received audio signal may be further stored in the memory 1602 or transmitted via the communication component 1608. In some embodiments, the audio component 1605 further includes a speaker to output audio signals.

The I/O interface 1606 provides an interface between the processing component 1601 and peripheral interface modules, such as a keyboard, a click wheel, buttons, and the like. The buttons may include, but are not limited to, a home button, a volume button, a starting button, and a locking button.

The sensor component 1607 includes one or more sensors to provide status assessments of various aspects of the device 1600. For instance, the sensor component 1607 may detect an open/closed status of the device 1600, relative positioning of components, e.g., the display and the keypad, of the device 1600, a change in position of the device 1600 or a component of the device 1600, a presence or absence of user contact with the device 1600, an orientation or an acceleration/deceleration of the device 1600, and a change in temperature of the device 1600. The sensor component 1607 may include a proximity sensor configured to detect the presence of nearby objects without any physical contact. The sensor component 1607 may further include a light sensor, such as a CMOS or CCD image sensor, for use in imaging applications. In some embodiments, the sensor component 1607 may further include an accelerometer sensor, a gyroscope sensor, a magnetic sensor, a pressure sensor, or a temperature sensor.

The communication component 1608 is configured to facilitate communication, wired or wirelessly, between the device 1600 and other devices. The device 1600 can access a wireless network based on a communication standard, such as WiFi, 2G, or 3G, or a combination thereof. In one exemplary embodiment, the communication component 1608 receives a broadcast signal or broadcast associated information from an external broadcast management system via a broadcast channel. In one exemplary embodiment, the communication component 1608 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 1600 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is further provided a non-transitory computer-readable storage medium storing instructions, such as those stored in the memory 1602, that, when executed by the processor 1609 in the device 1600, cause the device 1600 to perform part or all of the above-described methods. For example, the non-transitory computer-readable storage medium may be a ROM, a RAM, a CD-ROM, a magnetic tape, a floppy disc, an optical data storage device, and the like.

When instructions in the non-transitory computer readable storage medium are executed by a processor of a terminal, the terminal is enabled to perform a method for backing up a file consistent with embodiments of the present disclosure.

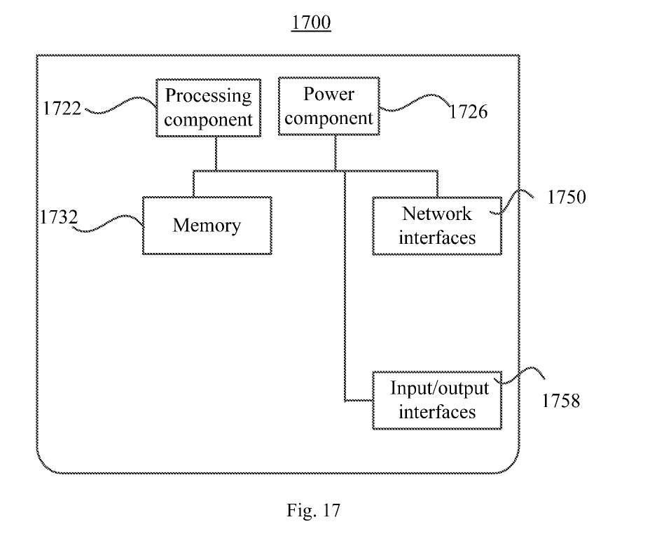

FIG. 17 is a block diagram of another device 1700 for backing up a file, according to an exemplary embodiment. The device 1700 may be provided as, for example, a server. Referring to FIG. 17, the device 1700 includes a processing component 1722, including one or more processors, and storage resources represented by a memory 1732 storing instructions executable by the processing component 1722, such as application programs. The application programs stored in the memory 1732 may include one or more modules each corresponding to a set of instructions. In addition, the processing component 1722 is configured to execute instructions to perform a method for backing up a file consistent with embodiments of the present disclosure.

The device 1700 further includes a power component 1726 configured to manage the power of the device 1700, a wired or wireless network interface 1750 configured connect the device 1700 to a network, and an input/output (I/O) interface 1758. The device 1700 may operate under an operating system stored in the memory 1732, such as Windows Server™, Mac OS X™, Unix™, Linux™, FreeBSD™, and the like.

In exemplary embodiments, there is further provided a non-transitory computer-readable storage medium storing instructions, such as those stored in the memory 1732, that, when executed by the processing component 1722 in the device 1700, cause the device 1700 to perform part or all of the above-described methods. For example, the non-transitory computer-readable storage medium may be a ROM, a RAM, a CD-ROM, a magnetic tape, a floppy disc, an optical data storage device, and the like.

When instructions in the non-transitory computer readable storage medium are executed by a processor of a device, the device is enabled to perform a method for backing up a file consistent with embodiments of the present disclosure.

According to the present disclosure, a hash value of a file is determined and inquired for to decide whether back-up of the file to a server is needed. As such, redundant back-up of the same file from different file paths can be avoided. In determining the hash value, a size of the file is checked against a preset threshold such that only file fragments are subjected to calculation when the size of the file is larger than or equals to the preset threshold. Thus, power consumption can be reduced. Further, the file fragments are evenly extracted from the file. Therefore, the hash value determined according to the file fragments can be kept as close to the actual hash value of the file as possible, and in the meantime the calculation workload is reduced. Moreover, for a hash value saved in a local back-up database, a mark is provided to indicate whether the file corresponding to that hash value has been successfully uploaded to the back-up server. This reduces the possibility of faulty operation due to unsuccessful uploading. According to the present disclosure, property information and a size of the file are recorded in the local back-up database. Hence a false judgment regarding backing up a file can be avoided.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A method for backing up files to a back-up server, comprising:
determining a hash value of a file according to a preset algorithm;
inquiring for the determined hash value in a local back-up database; and
canceling, if the hash value is recorded in the local back-up database, back-up of the file to the back-up server.

2. The method of claim 1, wherein determining the hash value includes:
judging whether a size of the file is larger than or equal to a preset threshold; and
if the size of the file is larger than or equal to the preset threshold:
extracting file fragments from the file, and
determining a first hash value according to the file fragments as the hash value of the file; or
if the size of the file is smaller than the preset threshold:
determining a second hash value according to the file as the hash value of the file.

3. The method of claim 2, wherein extracting the file fragments includes:
evenly extracting the file fragments from the file, each file fragment having a preset size, and a total size of the file fragments being smaller than the preset threshold.

4. The method of claim 1, further comprising:
uploading, if the hash value is not recorded in the local back-up database, the file to the back-up server; and
saving the hash value in the local back-up database.

5. The method of claim 4, further comprising:
marking the hash value as uploaded in the local back-up database after the file is successfully uploaded to the back-up server.

6. The method of claim 1, further comprising:
inquiring, if the hash value is recorded in the local back-up database, whether the hash value is marked as uploaded; and
if the hash value is marked as uploaded, canceling the back-up of the file to the back-up server; or
if the hash value is not marked as uploaded:
inquiring of the back-up server whether the file has previously been successfully uploaded; and
if the file has previously been successfully uploaded:
marking the hash value as uploaded in the local back-up database, and
canceling the back-up of the file to the back-up server; or
if the file has not previously been successfully uploaded, backing up the file to the back-up server.

7. The method of claim 1, wherein inquiring for the determined hash value in the local back-up database includes:
comparing property information of the file with recorded property information of an existing version of the file stored in the local back-up database, the property information containing a latest modification time and a size of the file; and
updating, if the property information of the file is different from the recorded property information, the hash value and the recorded property information stored in the local back-up database.

8. A method for backing up files, comprising:
receiving an inquiring request sent by a terminal, the inquiring request carrying an inquiring hash value;
inquiring for the inquiring hash value in a server back-up database; and
informing, if the inquiring hash value is recorded in the server back-up database, the terminal that a file corresponding to the inquiring hash value has previously been successfully uploaded.

9. The method of claim 8, further comprising:
determining a hash value of an uploaded file uploaded by the terminal according to a preset algorithm; and
saving the hash value of the uploaded file in the server back-up database.

10. The method of claim 9, wherein determining the hash value of the uploaded file includes:
judging whether a size of the uploaded file is larger than or equal to a preset threshold;
if the size of the uploaded file is larger than or equal to the preset threshold:
extracting file fragments from the uploaded file, and
determining a first hash value according to the file fragments as the hash value of the uploaded file; or
if the size of the uploaded file is smaller than the preset threshold:
determining a second hash value according to the uploaded file as the hash value of the uploaded file.

11. The method of claim 10, wherein extracting the file fragments includes:
evenly extracting the file fragments from the uploaded file, each file fragment having a preset size, and a total size of the file fragments being smaller than the preset threshold.

12. A device for backing up files, comprising:
a processor; and
a non-transitory computer-readable storage medium storing instructions that, when executed by the processor, cause the processor to:
determine a hash value of a file according to a preset algorithm;
inquire for the determined hash value in a local back-up database; and
cancel, if the hash value is recorded in the local back-up database, back-up of the file to the back-up server.

13. The device of claim 12, wherein the instructions further cause the processor to:
judge whether a size of the file is larger than or equal to a preset threshold; and
if the size of the file is larger than or equal to the preset threshold:
extract file fragments from the file, and
determine a first hash value according to the file fragments as the hash value of the file; or
if the size of the file is smaller than the preset threshold:
determine a second hash value according to the file as the hash value of the file.

14. The device of claim 13, wherein the instructions further cause the processor to:
evenly extract the file fragments from the file, each file fragment having a preset size, and a total size of the file fragments being smaller than the preset threshold.

15. The device of claim 12, wherein the instructions further cause the processor to:
upload, if the hash value is not recorded in the local back-up database, the file to the back-up server; and
save the hash value in the local back-up database.

16. The device of claim 15, wherein the instructions further cause the processor to:
mark the hash value as uploaded in the local back-up database after the file is successfully uploaded to the back-up server.

17. The device of claim 12, wherein the instructions further cause the processor to:
inquire, if the hash value is recorded in the local back-up database, whether the hash value is marked as uploaded; and
if the hash value is marked as uploaded, cancel the back-up of the file to the back-up server; or
if the hash value is not marked as uploaded:
inquire of the back-up server whether the file has previously been successfully uploaded, and
if the file has previously been successfully uploaded:
mark the hash value as uploaded in the local back-up database, and
cancel the back-up of the file to the back-up server; or
if the file has not previously been successfully uploaded, back up the file to the back-up server.

18. The device of claim 12, wherein the instructions further cause the processor to:
compare property information of the file with recorded property information of an existing version of the file stored in the local back-up database, the property information containing a latest modification time and a size of the file; and
update, if the property information of the file is different from the recorded property information, the hash value and the recorded property information stored in the local back-up database.

19. A device for backing up files, comprising:
a processor; and
a non-transitory computer-readable storage medium storing instructions that, when executed by the processor, cause the processor to:
inquire, in response to an inquiring request sent by a terminal and carrying an inquiring hash value, for the inquiring hash value in a server back-up database; and
inform, if the inquiring hash value is recorded in the server back-up database, the terminal that a file corresponding to the inquiring hash value has previously been successfully uploaded.

20. The device of claim 19, wherein the instructions further cause the processor to:
determine a hash value of an uploaded file uploaded by the terminal according to a preset algorithm; and
save the hash value of the uploaded file in the server back-up database.

21. The device of claim 20, wherein the instructions further cause the processor to:
judge whether a size of the uploaded file is larger than or equal to a preset threshold;
if the size of the uploaded file is larger than or equal to the preset threshold:
extract file fragments from the uploaded file, and
determine a first hash value according to the file fragments as the hash value of the uploaded file; or
if the size of the uploaded file is smaller than the preset threshold:
determine a second hash value according to the uploaded file as the hash value of the uploaded file.

22. The device of claim 21, wherein the instructions further cause the processor to:
evenly extract the file fragments from the uploaded file, each file fragment having a preset size smaller than the preset threshold.

23. A non-transitory computer-readable storage medium storing instructions that, when executed by one or more processors of a terminal, cause the terminal to:
determine a hash value of a file according to a preset algorithm;
inquire for the determined hash value in a local back-up database; and
cancel, if the hash value is recorded in the local back-up database, back-up of the file to the back-up server.

24. A non-transitory computer-readable storage medium storing instructions that, when executed by one or more processors of a device, cause the device to:
inquire, in response to an inquiring request sent by a terminal and carrying an inquiring hash value, for the inquiring hash value in a server back-up database; and
inform, if the inquiring hash value is recorded in the server back-up database, the terminal that a file corresponding to the inquiring hash value has previously been successfully uploaded.
